(19) United States
(12) Patent Application Publication
(10) Pub. No.: US 2011/0229621 A1
(43) Pub. Date: Sep. 22, 2011

(54) Novel natural mixed sweetener

(76) Inventor: Michael T Alexander, Oxford, CT (US)

(21) Appl. No.: 12/661,689

(22) Filed: Mar. 18, 2010

(51) Int. Cl. A23L 1/236

(52) U.S. Cl. 426/548

(57) ABSTRACT

It is well known that excessive use of plain table sugar—sucrose—in eg coffee and tea, (especially caffeinated), can within hours cause human blood sugar levels to initially rise and then quickly drop so low as to cause symptoms of fatigue and confusion . . . as the brain is no longer getting an adequate supply of sugar. This became problematic for me when I was unemployed so I decided to formulate an alternative sweetener. The end product is described in this paper. I personally have used this sweetener for over nine months and never experience the aforementioned symptoms which I did have with plain table sugar.

### BACKGROUND OF THE INVENTION

The field of endeavor is a novel natural sweetener.

### BRIEF SUMMARY OF INVENTION

This invention is an all natural sweetener that tastes like table sugar, (aka sucrose), but it has less calories. Furthermore it has no detectable off flavor or aftertaste which is commonly found in artificial sweeteners. Furthermore, when compared to table sugar, it does not have as significant impact on blood sugar levels. Clinical studies may indicate that this sweetener may be suitable for use by some or all Type One or Type Two diabetics and/or persons with hypoglycemia.

### DETAILED DESCRIPTION OF THE INVENTION

This natural sweetener is novel because it is composed of five (5) natural ingredients not blended before as follows:

| | |
|---|---|
| Table sugar | 32.43% by volume |
| Erythritol | 32.43% by volume |
| Dextrose | 32.43% by volume |
| Maltodextrin | 2.54% by volume |
| Stevia Extract | 0.27% by volume |

I blend these five ingredients as follows:
I have prepared the mixture in my own home as follows: To a one half gallon slider bag, using a graduated 150 ml glass beaker, I first add 120 ml table sugar. Then I add 120 ml Erythritol and sprinkle in one level teaspoon of a mixture of 90% Maltodextrin and 10% Stevia extract. I then close the slider on the bag and slide the ingredients back and forth three times. Then I reopen the bag and add 120 ml dextrose and sprinkle in another level teaspoon of the mixture of 90% Maltodextrin and 10% Stevia extract. I then seal the slider bag tightly and set a timer for 55 seconds. Holding the top of the bag I then start the timer and tumble the contents of the slider bag for the 55 second time interval. I then open the bag, and, using a plastic powder funnel I transfer the contents to a 16 ounce glass jar. I seal the jar with its screw cap then tumble and shake the jar five times.

This completes the preparation of the novel natural mixed sweetener.

1. This is a novel, all natural blend of sweeteners.

2. It has sweetness comparable to that of table sugar—sucrose.

3. It has less calories than table sugar.

4. It has no detectable off-flavor or any after taste.

5. It has less impact on human blood sugar levels than table sugar.

6. Clinical studies may indicate that it may be suitable for use by some or all Type 1 or Type 2 diabetics and/or by persons with hypoglycemia.
